(19) United States
(12) Patent Application Publication
(10) Pub. No.: US 2022/0073093 A1
(43) Pub. Date: Mar. 10, 2022

(54) METHOD AND SYSTEM FOR PREVENTIVE DRIVING CONTROL

(71) Applicant: RENAULT s.a.s., Boulogne-Billancourt (FR)

(72) Inventors: Vicente MILANES, Boulogne-Billancourt (FR); David GONZALEZ BAUTISTA, Saint Cyr l'ecole (FR)

(73) Assignee: RENAULT s.a.s., Boulogne-Billancourt (FR)

(21) Appl. No.: 17/413,386

(22) PCT Filed: Dec. 10, 2019
(86) PCT No.: PCT/EP2019/084450

§ 371 Date: Jun. 11, 2021

(30) Foreign Application Priority Data
Dec. 14, 2018 (FR) 18 72896

(51) Int. Cl. B60W 60/00; B60W 30/18; B62D 15/02

(52) U.S. Cl. CPC B60W 60/001; B60W 30/18145; B60W 2552/30; B60W 2552/53; B62D 15/021

(57) ABSTRACT

The guiding of an autonomous vehicle on a lane includes, when a bend entrance is detected, a first step of guiding the vehicle towards an outer part of the lane.

The invention relates to a method for guiding an autonomous vehicle. The invention also relates to a system for guiding a vehicle able to implement said method and to a motor vehicle comprising such a guidance system. The invention further relates to a computer program implementing such a method. The invention additionally relates to a storage medium on which such a program is stored. Lastly, the invention relates to a signal from a data medium carrying such a program.

Methods for guiding an autonomous vehicle work, for example, using the markings on the ground. Using cameras or infrared cameras, the vehicle detects the lines of the marking on the ground of the lane and determines a trajectory to be followed in order to remain in the middle of the lane between the two lines of the lane.

This type of guidance system is the simplest to implement but has drawbacks. By remaining in the middle of the lane, in particular in a bend, the vehicle does not take advantage of the entire width of the lane in order to save time, optimize grip, improve comfort for the user in the vehicle or to reduce the wear on the tires.

Document U.S. Pat. No. 9,919,708B2 discloses a guidance system comprising a plurality of driving modes, including a sport mode. Each driving mode guides the vehicle differently according to various adjustable preferences such as more or less sudden turning, aggressiveness of acceleration or deceleration, speed, lane change frequency or distance from the vehicle ahead. An interface allows the user to select one of these driving modes. However, this system does not make it possible to optimize the trajectory of the vehicle in a bend, and it appears in particular not to take safety considerations into account, especially in its sport mode.

The aim of the invention is to provide a system for guiding and a method for guiding an autonomous vehicle which overcome the above drawbacks and improve the guidance systems and methods known from the prior art. In particular, the invention makes it possible to provide a system and a method that are simple, reliable and that make it possible to optimize the trajectory of a vehicle in a bend, while in particular taking safety considerations into account.

The present invention relates to a method for guiding an autonomous vehicle on a lane, characterized in that the method comprises, when an entry to a bend is detected, a first step of guiding the vehicle toward an outer portion of the lane.

In one embodiment, the method comprises, when an exit from the bend is detected, a second step of guiding the vehicle toward an inner portion of the lane.

In one embodiment, the method comprises, at the exit from the bend, a third step of guiding the vehicle toward a centerline of the lane.

In one embodiment, the method comprises a step of detecting a curvature of the lane and, if a curvature is detected, a step of determining a bend entry or a bend exit.

In one embodiment, the method comprises a step of guiding the vehicle along the centerline of the lane when the vehicle does not detect a curvature of the lane.

In one embodiment, the step of guiding toward the outer portion of the lane when a bend entry is detected comprises the following sub-steps: using a sensor to detect a bend entry; and generating and transmitting a command to a device for orienting the steerable wheels of the vehicle in order to guide the vehicle toward the outer portion of the lane, in particular before the bend.

In one embodiment, the step of guiding toward the inner portion of the lane when a bend exit is detected comprises the following sub-steps: using a sensor to detect a bend exit; and generating and transmitting a command to a device for orienting the steerable wheels of the vehicle in order to guide the vehicle from the outer portion of the lane toward the inner portion of the lane during the bend.

The invention also relates to a system for guiding an autonomous vehicle, the system comprising hardware and/or software elements implementing the method according to the invention, in particular hardware and/or software elements designed to implement the method according to the invention, and/or the system comprising means for implementing the steps of the method according to the invention.

The invention further relates to a vehicle comprising a guidance system according to the invention.

The invention additionally relates to a computer program product comprising program code instructions that are stored on a computer-readable medium for implementing the steps of the method according to the invention when said program is run on a computer or a computer program product that is downloadable from a communication network and/or stored on a computer-readable and/or computer-executable data medium, comprising instructions which, when the program is executed by the computer, result in it implementing the steps of the method according to the invention.

The invention also relates to a data storage medium, which is readable by a computer, on which is stored a computer program comprising program code instructions for implementing the method according to the invention or a computer-readable storage medium comprising instructions which, when they are executed by a computer, result in it implementing the steps of the method according to the invention.

Lastly, the invention relates to a signal from a data medium, carrying the computer program product according to the invention.

The appended drawings show, by way of example, one embodiment of a guidance system according to the invention and one embodiment of a guidance method according to the invention.

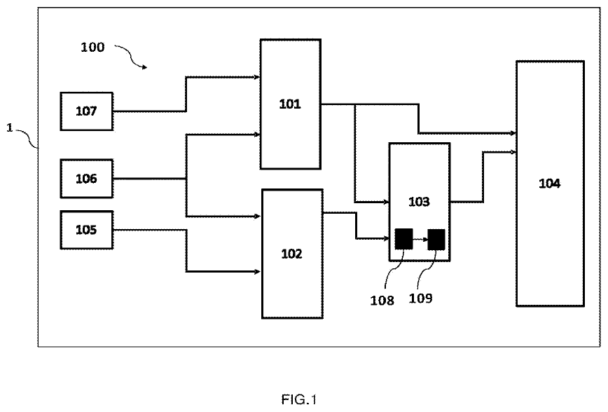

FIG. 1 shows a schematic view of a vehicle comprising a guidance system according to one embodiment of the invention.

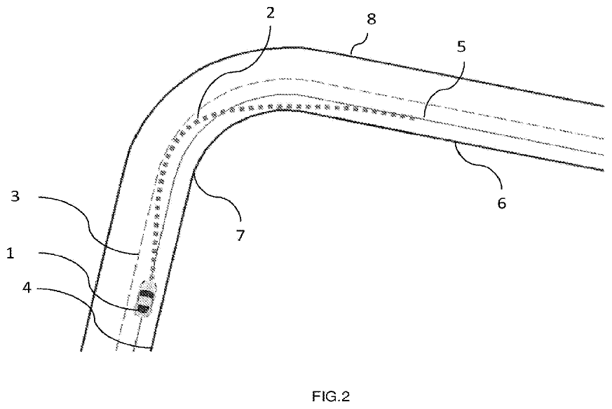

FIG. 2 shows a schematic view of the trajectory of a vehicle in a bend according to one embodiment of the method according to the invention.

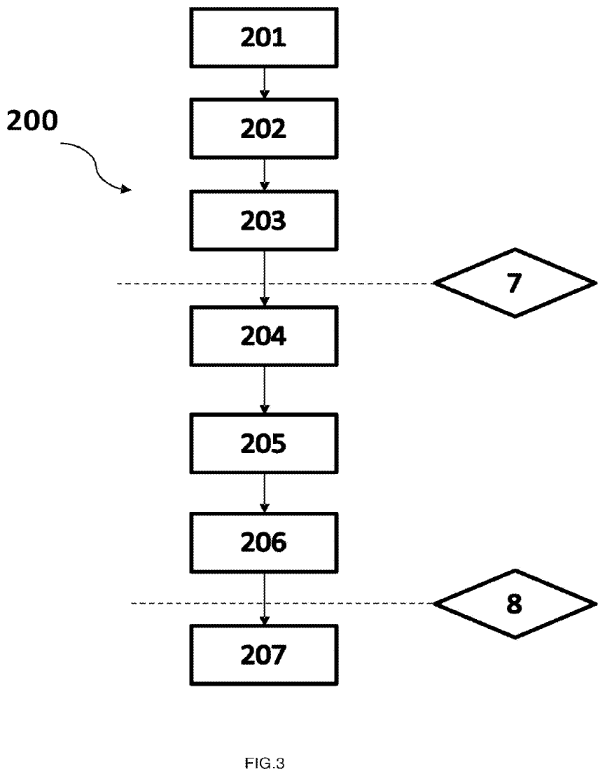

FIG. 3 shows a flow diagram of one embodiment of a guidance method according to the invention.

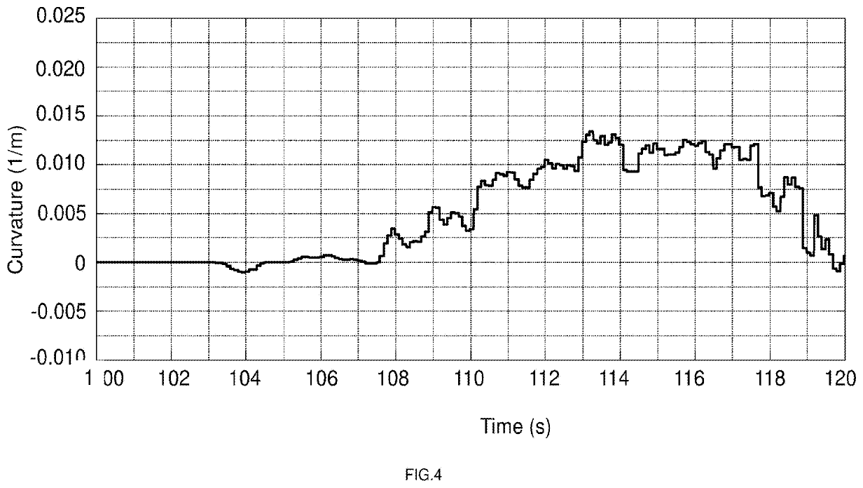

FIG. 4 is a graph showing the curvature of the trajectory of a vehicle as a function of time when the vehicle follows the centerline of the lane in a bend according to the prior art.

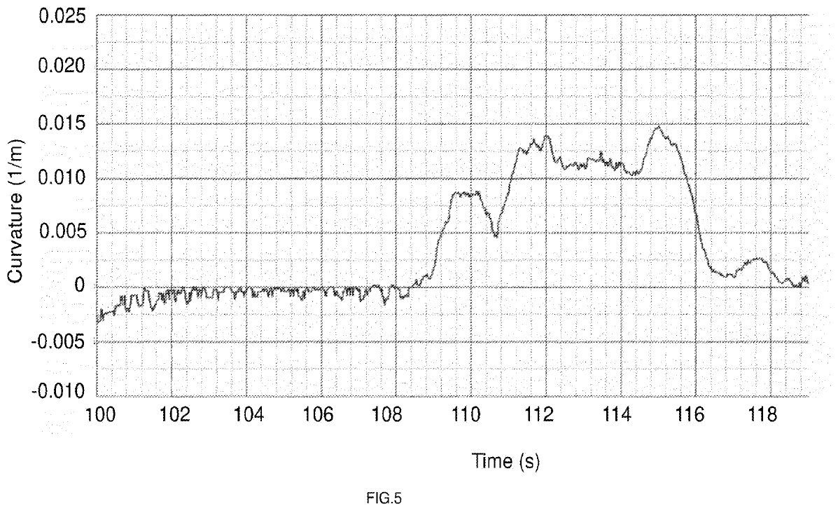

FIG. 5 is a graph showing the curvature of the trajectory of a vehicle as a function of time when the vehicle is equipped with a guidance system according to one embodiment of the invention, the vehicle following the same bend.

In the following description, the following terms are defined as follows:

What is meant by “guidance” is an operation allowing the steering of the vehicle to be controlled, providing the vehicle with a predetermined or calculated trajectory.

What is meant by “autonomous vehicle” is a vehicle equipped with an automatic steering or driving system that is able to drive and change direction without the intervention of a driver or user. This term may cover a fully autonomous vehicle and/or a “semi-autonomous” vehicle with various driving assistance systems.

What is meant by “lane” is the subdivision of a road allowing a series of vehicles to travel in a direction of travel and on which the vehicles may move, in a limited manner, widthwise. The lane is delimited laterally by two sidelines, which may be the marking lines on the ground or imaginary lines corresponding to the boundaries of the lane.

What is meant here by “centerline of the lane” is an imaginary line in the middle of the lane, equidistant from the sidelines of said lane. The centerline may have a thickness of less than or equal to 20 cm, preferably less than or equal to 10 cm.

On approaching a bend, what is meant by “outer portion of the lane” is the portion of the lane located between the centerline of the lane and the sideline of the lane that has the smallest curvature in the bend. In the present application, the curvature of a line refers to the inverse of the radius of curvature (in meters) of this line, and is therefore expressed in m⁻¹. Thus, the greater the radius of curvature, the smaller the curvature.

On approaching a bend, what is meant by “inner portion of the lane” is the portion of the lane between the centerline of the lane and the sideline of the lane that has the greatest curvature in the bend.

Preferably, the outer portion and the inner portion of the lane do not comprise the centerline of the lane.

What is meant by “entry to the bend” is the location on the lane where the centerline of the lane transitions from a rectilinear or substantially rectilinear direction to a curved direction in the direction of travel of the lane, in particular the location where the curvature of the centerline of the lane becomes greater than for example 0.0025 m⁻¹.

What is meant by “exit from the bend” is the location on the lane where the centerline of the lane transitions from a curved direction to a rectilinear or substantially rectilinear direction in the direction of travel of the lane, in particular the location where the curvature of the centerline of the lane becomes smaller than for example 0.0025 m⁻¹.

An example of a vehicle 1 equipped with one embodiment of the guidance system 100 is described below with reference to FIG. 1.

The vehicle 1 may be a motor vehicle such as a car, a truck or a two-wheeled vehicle.

The vehicle 1 comprises a guidance system 100 according to one embodiment of the invention.

The guidance system 100 comprises various sensors 105, 106, 107 allowing it to provide the information required to guide the vehicle 1. What is meant by “guidance system” is also an autonomous steering system for a motor vehicle, that is to say a system that makes it possible to control changes in the direction of the vehicle without the intervention of a user.

Preferably, the guidance system 100 comprises speed and steering sensors 107. These speed and steering sensors 107 are able to measure and transmit the speed of the vehicle 1 and the steering angle of the steerable wheels. These speed and steering sensors of the vehicle may comprise a sensor of the angular velocity of the vehicle 1.

The guidance system 100 further comprises a sensor 106 of the orientation of the vehicle and a reference trajectory sensor. The orientation sensor 106 may comprise a camera able to detect the marking lines on the ground of the lane and to deduce therefrom the relative position and the orientation of the vehicle with respect to the lane or with respect to the marking lines on the ground of the lane. The reference trajectory sensor may comprise a camera and a computer able to determine a polynomial describing the shape of the marking lines of the lane.

The guidance system 100 further comprises at least one guidance module such as modules 101 and 102, which are connected to the various sensors and able to generate a trajectory of the vehicle and/or transmit commands to a device 104 for orienting of the steerable wheels of the vehicle 1.

The guidance system 100 comprises a nominal guidance module 101. The nominal guidance module 101 is able to generate a trajectory so as to follow the centerline 5 of the lane. The nominal guidance module 101 is connected to the speed and steering sensors 107 of the vehicle and to the orientation sensor 106 of the vehicle, that is to say it uses data from these sensors to generate nominal trajectory data.

The nominal guidance module 101 makes it possible to generate a steering command for the vehicle that the vehicle 1 should execute in order to follow the nominal trajectory. Preferably, the nominal trajectory is a trajectory along a centerline 5 of a lane 6.

The guidance system 100 further comprises a sensor 105 able to determine the curvature of the lane. Said sensor 105 is preferably able to determine the curvature of the lane 6 at the point where the vehicle 1 is positioned or at the place where the vehicle is located and/or to determine the curvature of the lane 6 at a point located a predetermined distance ahead of the vehicle. Said sensor 105 of curvature of the lane preferably comprises a front camera. Said front camera is arranged toward the front of the vehicle 1. Said front camera records images comprising at least one representation of at least one sideline of the lane and deduces therefrom the angle of curvature of said sideline over a predetermined distance. In one embodiment, the camera is able to detect a curvature of the lane at the position of the vehicle and/or over a distance that may be up to 100 m ahead of the vehicle.

In one embodiment, the guidance system 100 comprises a bend detection module 102. The bend detection module 102 is preferably configured to receive the data from said sensor 105 able to determine the curvature of the lane. The bend detection module 102 is configured to detect, on the basis of its data, the entry to the bend 204 and/or the exit from the bend 210. The bend detection module 102 is also configured to calculate the distance between the vehicle 1 and the entry to the bend 204 and/or the exit from the bend 210.

The system 100 further comprises a predictive guidance module 103. The predictive guidance module 103 is able to generate a trajectory 2 to be followed by the vehicle on the basis of the information that the module 103 receives. The predictive guidance module 103 is connected to the various modules 101, 102.

The predictive guidance module 103 makes it possible to generate a steering command that the vehicle 1 has to execute in order to follow a trajectory 2 that it has generated. The predictive guidance module 103 may thus comprise a computer 109 connected to a data storage medium 108. The data storage medium 108 comprises instructions to be executed by the computer 109 in order to generate said steering command.

The guidance system 100 comprises a device 104 for orienting the steerable wheels of the vehicle 1. The orienting device 104 comprises means for controlling the orientation of the wheels of the vehicle. The orienting device 104 is able to control the steering of the vehicle according to the commands it receives from the predictive guidance module 102 and/or from the nominal guidance module 101. The orienting device comprises an actuator, in particular an electric actuator. For example, the actuator is able to act on the steering of the vehicle, in particular being able to turn a steering column of the vehicle. The actuator is driven by signals from the modules 101 and 103.

In one embodiment, the system 100 may alternate between the use of the nominal guidance module 101 and the use of the predictive guidance module 103. Preferably, the guidance system 100 comprises a user interface (not shown) allowing the user to select which module to use.

The invention also relates to a method 200 for guiding an autonomous vehicle on a lane. The method 200 may also consist of a method for operating an autonomous steering and/or guidance system 100 for a motor vehicle 1 described above.

One embodiment of the method 200 for guiding an autonomous vehicle 1 or of the method for operating an autonomous steering system is described below with reference to FIG. 3. This embodiment is described in the case illustrated in FIG. 2 where the vehicle 1 is driving on a lane 6 that has a rectilinear portion before a bend, then the bend itself, and finally a rectilinear portion after the bend.

The lane 6 comprises a bend entry 7 and a bend exit 8. The lane 6 comprises an inner sideline 4 represented by a continuous marking in the present example and an outer sideline 3 represented by a broken marking in the present example, making it possible to determine an imaginary centerline 5 of the lane 6. The trajectory 2 of the vehicle according to one embodiment of the method 200 on said lane 6 is illustrated with a dotted line.

In a first step 201, the vehicle 1 is on a straight or rectilinear portion. The vehicle 1 then follows a rectilinear trajectory or follows a trajectory on the centerline 5 of the lane 6.

In a second step 202, the entry 7 to a bend is detected. The entry 7 to the bend may be detected by the sensor 105 that is able to determine the curvature of the lane such as a camera or the bend detection module 102. The bend detection module 102 receives the data from said sensor 105 such as a camera and calculates the curvature of a visible line of the lane over a distance range ahead of the vehicle. The module 102 detects the location where said line transitions from a zero or substantially zero curvature (rectilinear line) to a positive or negative curvature and notes this location as the entry 7 to the bend.

In a third step 203, the vehicle 1 is still on the straight road portion before the entry 7 to the bend, and the vehicle 1 is guided to an outer portion of the lane, between the outer sideline 3 and the centerline 5; in particular, the vehicle is guided so that its center of gravity is positioned in the outer portion of the lane. In particular, the vehicle 1 is guided so as no longer to be centered on the centerline 5. In other words, the vehicle 1 is brought closer to the sideline 3 of the lane 6 that has the smallest curvature.

In other words, the method 200 comprises, before the entry 7 to the bend, a step of guiding the vehicle 1 along a trajectory the curvature of which is smaller than that of the centerline 5 or the sign (positive or negative) of the curvature of which is the opposite of the sign of the curvature of the centerline 5 of the lane at the entry 7 to the bend and in the bend.

The vehicle 1 thus arrives at the entry 7 to the bend positioned in the outer portion of the lane 6. In a fourth step 204, the vehicle 1 starts the bend with a trajectory 2 that has a mean curvature smaller than the curvature of the centerline 5.

In a fifth step 205, the exit 8 from the bend is detected ahead of the vehicle 1, for example 30 m ahead of the vehicle 1. The detection of the exit 8 from the bend is similar to the detection of the entry 7 to the bend. The bend detection module 102 determines the exit 8 from the bend as the location where the curvature of a visible line of the lane transitions from a positive or negative curvature to a zero or substantially zero curvature (rectilinear line). The fourth step 204 may not be carried out if the detection of the exit 8 from the bend occurs early enough, in particular before the vehicle 1 reaches the entry 7 to the bend.

In a fifth step 205, the guidance system 100 increases the angle of the orientation of the steerable wheels so as to increase the curvature of the trajectory 2 of the vehicle 1. Preferably, the curvature of the trajectory of the vehicle is increased so that said curvature is greater than the curvature of the centerline 5. In one embodiment, said curvature is for example 1.3 times greater than the curvature of the centerline 5. In other words, the method comprises a step of guiding the vehicle 1 along a trajectory 2 the curvature of which is greater than the curvature of the centerline 5 of the lane 6.

The vehicle 1 thus crosses the centerline 5 and is guided to the inner portion of the lane 6, that is to say between the inner sideline 4 and the centerline 5. In other words, the method 200 comprises a step of guiding the vehicle 1 to the inner portion of the lane when an exit 8 to a bend is detected; in particular, the vehicle is guided so that its center of gravity is positioned in the inner portion of the lane. In other words, the vehicle is brought closer to the sideline of the lane that has the greatest curvature.

The method 200 comprises a sixth step 206 of guiding the vehicle 1 along a trajectory 2 the curvature of which decreases. The curvature of the trajectory 2 decreases in such a way that the vehicle “cuts” the bend by passing close to the inner sideline 4 of the lane and then back toward the centerline 5. In other words, the method 200 comprises a step of guiding the vehicle 1 along a trajectory the curvature of which is smaller than the curvature of the centerline 5 of the lane 6. For example, said curvature is 0.85 times smaller than the curvature of the centerline 5.

Once the exit 8 from the bend has been passed by the vehicle 1, the method 200 may comprise a seventh step 207 of the vehicle 1 following the centerline 5.

In all of these steps, the actuator is controlled so as to produce the desired changes in direction of the vehicle corresponding to the logic described above.

This trajectory makes it possible to optimize the grip of the vehicle in the bend.

In other words, the method comprises
before the entry 7 to the bend, a step of guiding the vehicle along a trajectory in order to guide it to an outer portion of the lane at the bend entry, then;
a step of guiding the vehicle along a trajectory the curvature of which is smaller than the curvature of the centerline of the lane, for example 0.85 times smaller, then;
a step of guiding the vehicle along a trajectory the curvature of which is greater than the curvature of the centerline of the lane, for example 1.3 times greater.

The guidance system 100 is configured to execute the guidance method according to the present invention. The predictive guidance module 103 is configured to transmit, to the device 104 for orienting the steerable wheels, commands for executing the method 200 according to the present invention.

The guidance system 100 comprises hardware and/or software elements 101, 102, 103, 104, 105, 106, 107, 108, 109 implementing or governing a method for guiding an autonomous vehicle. In particular, the guidance system 100 comprises the hardware and/or software elements 101, 102, 103, 104, 105, 106, 107, 108, 109 allowing the steps of the guidance method to be implemented. These various elements may comprise software modules.

The data storage medium 108 comprises a computer program comprising program code instructions for implementing the method according to the invention or comprises instructions which, when they are executed by a computer or the computer 109, result in it implementing the steps of the method 200 according to the invention.

The results of tests conducted in order to test a vehicle 1 comprising a guidance system 100 according to one embodiment are reported in FIGS. 4 and 5.

In a first test, a vehicle is driven which comprises a guidance system designed so that the vehicle follows, according to the prior art, the centerline 5 of the lane in a bend.

The vehicle is driven at a constant speed on a road portion comprising a rectilinear portion and then a bend. While driving, the curvature of the trajectory of the vehicle as a function of time is read (FIG. 4).

FIG. 4 shows that at about 108 seconds, the trajectory begins to change so as to follow the centerline 5 of the bend.

In a second test, a vehicle 1 is driven which comprises a guidance system 100 according to one embodiment of the present invention at the same speed as in the first test and on the same road portion.

The graph of the curvature of the trajectory of the vehicle as a function of time in the second test is reported in FIG. 5.

In the graph illustrated in FIG. 5, the entry to the bend 204 is also at around 108 seconds.

A difference may be observed when the exit 8 from the bend is detected by the front camera of the vehicle.

A peak in the curvature of the trajectory may be observed at 115 seconds, indicating that the exit 8 from the bend has just been detected by the bend detection module 102, changing the trajectory so as to seek the inside of the lane rather than the outside of the lane.

Once the peak in curvature has been passed and the vehicle positioned in a direction so as to “cut” the bend, the curvature of the trajectory decreases abruptly.

This change in trajectory imposes a greater curvature on the trajectory but makes it possible to complete the bend ahead of time with respect to the first test (the curvature is 0+/−0.0025 at 117 seconds in the second test instead of 119 seconds in the first test). This is the bend profile that would be followed by a professional driver with a view to maximizing safety.

1-11. (canceled)

12. A method for guiding an autonomous vehicle on a lane, comprising:
guiding, when an entry to a bend is detected, the vehicle toward an outer portion of the lane and then, when an exit from the bend is detected, guiding the vehicle toward an inner portion of the lane, crossing a centerline of the lane.

13. The guidance method as claimed in claim 12, further comprising, at the exit from the bend, guiding the vehicle toward the centerline of the lane.

14. The guidance method as claimed in claim 13, further comprising detecting a curvature of the lane and, when the curvature is detected, determining a bend entry or a bend exit.

15. The guidance method as claimed in claim 12, further comprising guiding the vehicle along the centerline of the lane when the vehicle does not detect a curvature of the lane.

16. The guidance method as claimed in claim 12, wherein the guiding toward the outer portion of the lane when a bend entry is detected comprises:
using a sensor to detect the bend entry; and
generating and transmitting a command to a device for orienting steerable wheels of the vehicle in order to guide the vehicle toward the outer portion of the lane.

17. The guidance method as claimed in claim 12, wherein the guiding toward the outer portion of the lane when a bend entry is detected comprises:
using a sensor to detect the bend entry; and
generating and transmitting a command to a device for orienting steerable wheels of the vehicle in order to guide the vehicle toward the outer portion of the lane before the bend.

18. The guidance method as claimed in claim 12, wherein the guiding toward the inner portion of the lane when a bend exit is detected comprises:
using a sensor to detect the bend exit; and
generating and transmitting a command to a device for orienting steerable wheels of the vehicle in order to guide the vehicle from the outer portion of the lane to the inner portion of the lane during the bend.

19. A system for guiding an autonomous vehicle, the system comprising:
hardware and/or software elements configured to implement the method as claimed in claim 12.

20. A vehicle comprising:
a guidance system as claimed in claim 19.

21. A non-transitory data storage medium, which is readable by a computer, on which is stored a computer program comprising program that, when executed by a computer, cause the computer to execute the method as claimed in claim 12.
